(19) United States
(12) Patent Application Publication
(10) Pub. No.: US 2024/0418781 A1
(43) Pub. Date: Dec. 19, 2024

(54) BATTERY DATA MANAGEMENT APPARATUS AND OPERATING METHOD THEREOF

(71) Applicant: LG ENERGY SOLUTION, LTD., Seoul (KR)

(72) Inventors: Byeong Gyu HYEON, Daejeon (KR); Seung Kyu PAEK, Daejeon (KR); Chung Yong LEE, Daejeon (KR); Young CHOI, Daejeon (KR)

(73) Assignee: LG ENERGY SOLUTION, LTD., Seoul (KR)

(21) Appl. No.: 18/702,324

(22) PCT Filed: Oct. 20, 2022
(86) PCT No.: PCT/KR2022/016039

§ 371 Date: Apr. 17, 2024

(30) Foreign Application Priority Data
Nov. 1, 2021 (KR) 10-2021-0148332

(51) Int. Cl. G01R 31/367; G01R 31/371

(52) U.S. Cl. CPC G01R 31/367; G01R 31/371

(57) ABSTRACT

A battery data management apparatus according to an example embodiment disclosed herein includes a plurality of functional modules configured to perform a defined function based on a preset algorithm, a first broker configured to relay linked operations among the plurality of functional modules based on battery data of at least any one functional module among the plurality of functional modules, and a first controller configured to control operations of the plurality of functional modules and the first broker.

### CROSS-REFERENCE TO RELATED APPLICATION

This application claims priority to and the benefit of Korean Patent Application No. 10-2021-0148332 filed in the Korean Intellectual Property Office on Nov. 1, 2021, the entire contents of which are incorporated herein by reference.

### TECHNICAL FIELD

Example embodiments disclosed herein relate to a battery data management apparatus and an operating method thereof.

### BACKGROUND ART

An energy storage system (ESS) stores high-capacity electric energy in a plurality of battery racks including a plurality of battery modules connected in series and/or in parallel. The battery rack of the ESS may have heat generated therein by chemical reaction occurring in a process of charging and discharging electricity, and the heat may impair performance and lifetime of the battery rack. Thus, the battery rack may transmit battery data including temperature, voltage, and current of the battery rack to a battery system controller (BSC) for management.

However, such a high-capacity BSC performs various functions such as data communication, data logging, etc., as a single system, and needs a high-performance system, resulting in problems like an installation cost and a lot of resources for maintenance.

### DISCLOSURE

### [Technical Objective]

Example embodiments disclosed herein aim to provide a battery data management apparatus and an operating method thereof, in which various modules may quickly process battery data at the same time and efficiently manage battery data, by distributing operations of functional modules.

Technical objectives of the example embodiments disclosed herein are not limited to the above-described technical objectives, and other unmentioned technical objectives would be clearly understood by one of ordinary skill in the art from the following description.

### Technical Solution

A battery data management apparatus according to an example embodiment disclosed herein includes a plurality of functional modules configured to perform a defined function based on a preset algorithm, a first broker configured to relay linked operations among the plurality of functional modules based on battery data of at least any one functional module among the plurality of functional modules, and a first controller configured to control operations of the plurality of functional modules and the first broker.

According to an example embodiment, the plurality of functional modules may be further configured to perform a defined function based on a control command of the first controller. According to an example embodiment, the plurality of functional modules may be further configured to transmit the battery data by performing battery data communication with the first broker.

According to an example embodiment, the first broker may be further configured to cache battery data of at least any one functional module among the plurality of functional modules.

According to an example embodiment, the first broker may be further configured to relay the battery data, cached from the plurality of functional modules, among the plurality of functional modules.

According to an example embodiment, the controller may be further configured to, when a failure occurs in at least any one functional module among the plurality of functional modules, control another functional module to perform a defined function of the functional module.

According to an example embodiment, the battery data management apparatus may further include a second broker configured to relay linked operations among the plurality of functional modules based on battery data of at least any one functional module among the plurality of functional modules and a second controller configured to control operations of the plurality of functional modules and the second broker.

According to an example embodiment, the first broker and the second broker may be further configured to share the battery data cached from the plurality of functional modules.

According to an example embodiment, the first broker or the second broker may be further configured to transmit the battery data cached from at least any one functional module among the plurality of functional modules to the second broker or the first broker.

According to an example embodiment, the first controller or the second controller may be further configured to, when a failure occurs in the first broker or the second broker, control at least any one functional module among the plurality of functional modules performing battery data communication with the first broker or the second broker to perform battery data communication with the second broker or the first broker.

An operating method of a battery data management apparatus according to an example embodiment disclosed herein includes performing, by a plurality of functional modules, a defined function based on a preset algorithm, relaying, by a first broker, linked operations among the plurality of functional modules based on battery data of at least any one functional module among the plurality of functional modules and controlling, by a first controller, operations of the plurality of functional modules and the first broker.

According to an example embodiment, the controlling, by the first controller, of the operations of the plurality of functional modules and the first broker may include, when a failure occurs in at least any one functional module among the plurality of functional modules, controlling, by the first controller, another functional module to perform a defined function of the functional module.

According to an example embodiment, the operating method may further include relaying, by a second broker, linked operations among the plurality of functional modules based on battery data of at least any one functional module among the plurality of functional modules and controlling, by a second controller, operations of the plurality of functional modules and the second broker.

According to an example embodiment, the relaying, by the first broker, of the linked operations among the plurality of functional modules based on battery data of at least any one functional module among the plurality of functional modules may include transmitting, by the first broker, the battery data cached from at least any one functional module among the plurality of functional modules to the second broker, and the relaying, by the second broker, of the linked operations among the plurality of functional modules based on battery data of at least any one functional module among the plurality of functional modules may include transmitting, by the second broker, the battery data cached from at least any one functional module among the plurality of functional modules to the first broker.

According to an example embodiment, the controlling, by the first controller, of the operations of the plurality of functional modules and the first broker may include, when a failure occurs in the first broker, controlling, by the first controller, at least any one functional module among the plurality of functional modules performing battery data communication with the first broker to perform battery data communication with the second broker, and the controlling, by the second controller, of the operations of the plurality of functional modules and the second broker may include, when a failure occurs in the second broker, controlling, by the second controller, at least any one functional module among the plurality of functional modules performing battery data communication with the second broker to perform battery data communication with the first broker.

### Advantageous Effects

With a battery data management apparatus and an operating method thereof, it is possible to quickly process battery data at the same time and efficiently manage battery data, by distributing operations of functional modules.

### BRIEF DESCRIPTION OF DRAWINGS

FIG. 1 is a view schematically showing a configuration of an energy storage system to which a battery data management apparatus according to an example embodiment disclosed herein is applied.

FIG. 2 is a view for describing in detail a configuration of a battery data management apparatus according to an example embodiment disclosed herein.

FIG. 3 is a view for describing in detail a configuration of a battery data management apparatus according to another example embodiment disclosed herein.

FIG. 4 is a flowchart of an operating method of a battery management apparatus according to an example embodiment disclosed herein.

FIG. 5 is a block diagram showing a hardware configuration of a computing system for performing an operating method of a battery data management apparatus, according to an example embodiment disclosed herein.

### MODES FOR PRACTICING INVENTION

Hereinafter, some example embodiments disclosed in this document will be described in detail with reference to the example drawings. In adding reference numerals to components of each drawing, it should be noted that the same components are given the same reference numerals even though they are indicated in different drawings. In addition, in describing the example embodiments disclosed in this document, when it is determined that a detailed description of a related known configuration or function interferes with the understanding of an example embodiment disclosed in this document, the detailed description thereof will be omitted.

To describe a component of an example embodiment disclosed herein, terms such as first, second, A, B, (a), (b), etc., may be used. These terms are used merely for distinguishing one component from another component and do not limit the component to the essence, sequence, order, etc., of the component. The terms used herein, including technical and scientific terms, have the same meanings as terms that are generally understood by those skilled in the art, as long as the terms are not differently defined. Generally, the terms defined in a generally used dictionary should be interpreted as having the same meanings as the contextual meanings of the relevant technology and should not be interpreted as having ideal or exaggerated meanings unless they are clearly defined in the present document.

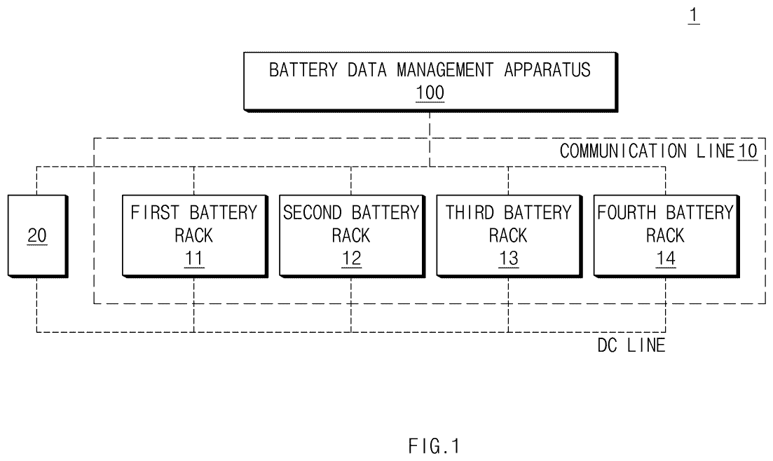

FIG. 1 is a view schematically showing a configuration of an energy storage system to which a battery data management apparatus according to an example embodiment disclosed herein is applied.

Referring to FIG. 1, an energy storage system (ESS) 1 may include a battery bank 10, a power conversion system (PCS) 20, and a battery data management apparatus 100.

The battery data management apparatus 100 may control a plurality of batteries of the battery bank 10 to obtain battery data. The battery data management apparatus 100 may perform data communication with the plurality of batteries to receive battery data related to the plurality of batteries. For example, the battery data management apparatus 100 may receive temperature and voltage measurement values of the plurality of batteries, and SoC and SoH parameters derived therefrom, from the plurality of batteries.

According to an example embodiment, the battery data management apparatus 100 may be implemented in the form of a battery system controller (BSC) to control operations of the plurality of batteries. That is, the battery data management apparatus 100 may communicate with a controller included in the battery system. The battery data management apparatus 100 may transmit a control signal to the battery system to control the operations of the plurality of batteries. In addition, the battery data management apparatus 100 may receive the battery data from the battery system to manage a state of the battery system.

The battery data management apparatus 100 may analyze and manage the battery data obtained from the plurality of batteries by using internal components having rich computing resources. The battery data management apparatus 100 may also accurately analyze an abnormal phenomenon of the battery data through internal components to diagnose abnormal states of the plurality of batteries.

Herein, the plurality of batteries may be implemented in the form of the plurality of battery racks installed in the energy storage system and storing electric energy, according to an example embodiment. The battery rack may be a unit that stores electric energy in the energy storage system. The energy storage system may include one or more battery banks including the plurality of battery racks. The battery bank may include the plurality of battery racks and a bank battery management system (BBMS).

Each of the plurality of battery racks may include a plurality of battery modules, a charging/discharging device, and a rack BMS (RBMS) controlling the plurality of module BMSs controlling the plurality of battery modules. Herein, the plurality of battery modules may supply power to a target device (not shown). To this end, the battery module may be electrically connected to the target device. Herein, the target device may include an electrical, electronic, or mechanical device that operates by receiving power from each of the plurality of battery racks including the plurality of battery modules, and for example, the target device may be, but not limited to, an ESS. Each of the plurality of battery modules may include a plurality of battery cells connected in series and/or in parallel. The plurality of battery cells may be a lithium ion (Li-ion) battery, an Li-ion polymer battery, a nickel-cadmium (Ni—Cd) battery, a nickel hydrogen (Ni-MH) battery, etc., and are not limited thereto.

Hereinbelow, it will be described on the assumption that the plurality of batteries are implemented in the form of a battery bank including the plurality of battery racks.

The battery bank 10 may include a first battery rack 11, a second battery rack 12, a third battery rack 13, and a fourth battery rack 14. Although the plurality of battery racks are illustrated as four in FIG. 1, the present disclosure is not limited thereto, and the battery bank 10 may include n battery racks (n is a natural number equal to or greater than 1).

The battery data management apparatus 100 may manage each component included in the ESS 1 and control an overall operation. That is, the battery data management apparatus 100 may control operations of a plurality of battery racks 11, 12, 13, and 14 and the PCS 20 included in the ESS 1.

First, the battery data management apparatus 100 may receive the battery data from the plurality of battery racks 11, 12, 13, and 14 to manage states of the detail plurality of battery racks 11, 12, 13, and 14. More specifically, the battery data management apparatus 100 may communicate with a controller (e.g., a rack BMS) included in the plurality of battery racks 11, 12, 13, and 14. The battery data management apparatus 100 may receive the battery data from a controller included in the plurality of battery racks 11, 12, 13, and 14 to manage the states of the detail plurality of battery racks 11, 12, 13, and 14.

In addition, the battery data management apparatus 100 may transmit a control signal to the plurality of battery racks 11, 12, 13, and 14 to control operations of the detail plurality of battery racks 11, 12, 13, and 14.

The battery data management apparatus 100 may transmit a control signal to the PCS 20 to control a power conversion operation of the PCS 20. The PCS 20 may perform the power conversion operation under control of the battery data management apparatus 100.

Herein, the PCS 20 may convert an alternating-current power into a direct-current power (AC/DC convert) or convert a direct-current power into a direct-current power (DC/DC convert) to supply the converted direct-current power to the plurality of battery racks 11, 12, 13, and 14. The PCS 20 may convert the direct-current power supplied from the plurality of battery racks 11, 12, 13, and 14 into an alternating-current power. The PCS 20 may supply the converted alternating-current power to a load (not shown).

The plurality of battery racks 11, 12, 13, and 14 may be charged using the direct-current power supplied from the PCS 20. In addition, the plurality of battery racks 11, 12, 13, and 14 may perform a discharge operation by outputting the direct-current power to supply the same to the PCS 20.

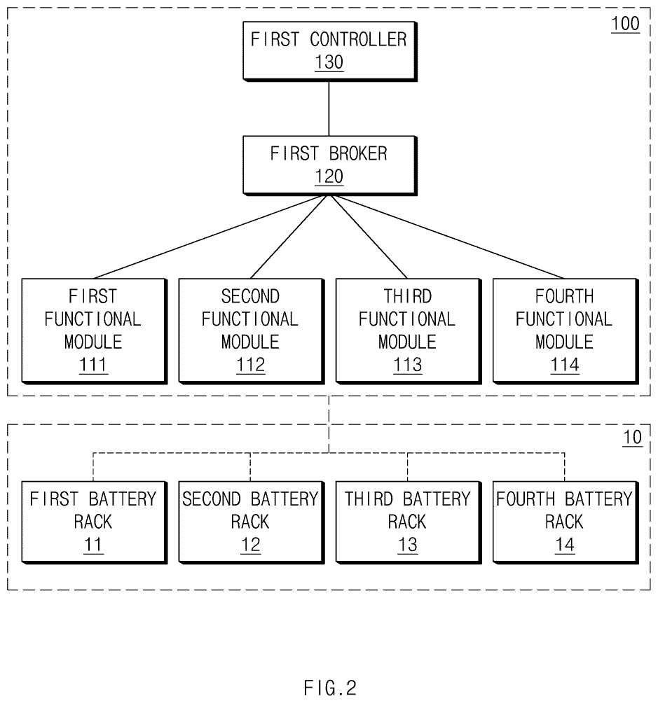

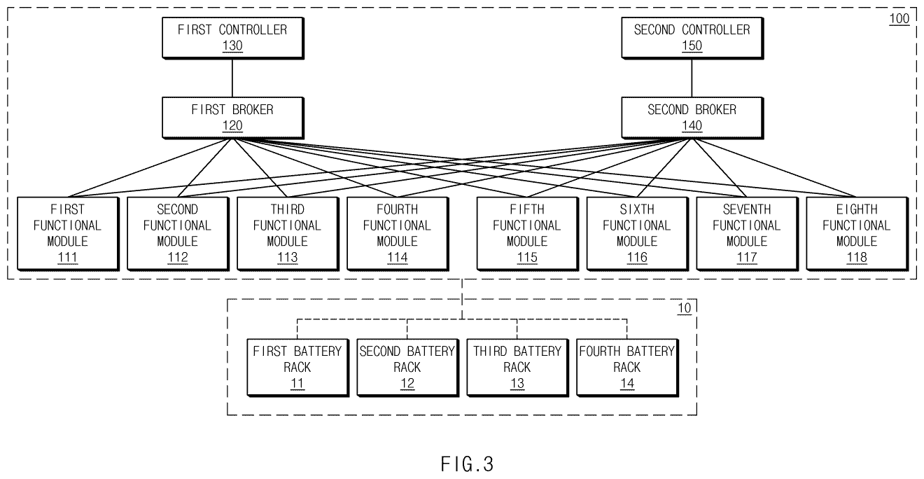

FIG. 2 is a view for describing in detail a configuration of a battery data management apparatus according to an example embodiment disclosed herein. FIG. 3 is a view for describing in detail a configuration of a battery data management apparatus according to another example embodiment disclosed herein.

Hereinbelow, a configuration of the battery data management apparatus 100 will be described with reference to FIGS. 2 and 3.

First, referring to FIG. 2, the battery data management apparatus 100 may include a plurality of functional modules 110, a first broker 120, and a first controller 130.

The plurality of functional modules 110 may include a first functional module 111, a second functional module 112, a third functional module 113, and a fourth functional module 114. Although the plurality of functional modules are illustrated as four in FIG. 2, the present disclosure is not limited thereto, and the plurality of functional modules 110 may include n functional modules (n is a natural number equal to or greater than 2).

Each of the plurality of functional modules 111, 112, 113, and 114 may perform a defined function based on a preset algorithm. For example, each of the plurality of functional modules 111, 112, 113, and 114 may perform any one of battery data communication with the plurality of battery racks 11, 12, 13, and 14, control of the plurality of battery racks 11, 12, 13, and 14, and a user interface (UI) operation or battery data logging of the ESS 1 to which the battery data management apparatus 100 is applied. That is, the battery data management apparatus 100 may support load distribution by distinguishing functions of each of the plurality of function modules 111, 112, 113, and 114.

More specifically, each of the plurality of functional modules 111, 112, 113, and 114 may perform a defined function based on a control command of the first controller 130. That is, each of the plurality of functional modules 111, 112, 113, and 114 may perform a designated function based on a control command of the first controller 130.

For example, any one of the plurality of functional modules 111, 112, 113, and 114 may perform battery data communication with the plurality of battery racks 11, 12, 13, and 14 to obtain battery data. For example, the first functional module 111 may perform wired and/or wireless communication with the first battery rack 11 that is any one of the plurality of battery racks 11, 12, 13, and 14. For example, the first functional module 111 may communicate with the first battery rack 11 according to a differential input mode communication protocol. Herein, examples of the differential input mode communication protocol may include a controller area network (CAN), recommended standard 485 (RS-485), recommended standard 422 (RS-422), etc. In addition, for example, the first functional module 111 may communicate with the first battery rack 11 according to a wireless communication protocol such as Wi-Fi (registered trademark), Bluetooth (registered trademark), etc.

Each of the plurality of functional modules 111, 112, 113, and 114 may perform battery data communication with the first broker 120 to transmit the obtained battery data or the generated battery data. That is, the first broker 120 may obtain the battery data from the plurality of functional modules 111, 112, 113, and 114.

The first broker 120 may relay linked operations among the plurality of functional modules 111, 112, 113, and 114 based on the battery data obtained from at least any one function module among the plurality of functional modules 111, 112, 113, and 114. More specifically, the first broker 120 may cache the battery data of the at least any one functional module among the plurality of functional modules 111, 112, 113, and 114. The first broker 120 may relay the plurality of functional modules 111, 112, 113, and 114 based on the battery data cached from the plurality of functional modules 111, 112, 113, and 114.

For example, when the second functional module 112 may perform a designated function based on the battery data obtained by the first functional module 111 among the plurality of functional modules 111, 112, 113, and 114, the first broker 120 may transmit the battery data cached from the first functional module 111 to the second functional module 112 to relay the linked operations among the plurality of functional modules 111, 112, 113, and 114.

In addition, for example, when a failure occurs in the first functional module 111 among the plurality of functional modules 111, 112, 113, and 114, the first broker 120 may transmit the battery data cached from the first functional module 111 where the failure occurs to the second functional module 112 that is drivable to relay operations among the plurality of functional modules 111, 112, 113, and 114.

The first controller 130 may control operations of the plurality of functional modules 111, 112, 113, and 114 and the first broker 120. When a failure occurs in at least any one functional module among the plurality of functional modules 111, 112, 113, and 114, the first controller may control another drivable functional module to perform a designated function of the functional module. More specifically, when a failure occurs in at least any one functional module among the plurality of functional modules 111, 112, 113, and 114, the first controller may transmit a control command such that another drivable functional module performs the function.

According to an example embodiment, the battery data management apparatus 100 may drive each of the plurality of functional modules 111, 112, 113, and 114, the first broker 120 that manages the battery data of the plurality of functional modules 111, 112, 113, and 114, and the first controller 130 that controls the plurality of functional modules 111, 112, 113, and 114 and the first broker as a separate hardware device to perform a vertical scaling function. That is, to drive each of the plurality of functional modules 111, 112, 113, and 114, the first broker 120, and the first controller 130 of the battery data management apparatus 100 as a separate hardware device, application processing ability and storage capacity may be scaled up.

Referring to FIG. 3, the battery data management apparatus 100 may further include a second broker 140 and a second controller 150.

The second broker 140 may relay linked operations among a plurality of functional modules 115, 116, 117, and 118 based on the battery data of at least any one function module among the plurality of functional modules 115, 116, 117, and 118. That is, the second broker 140 may horizontally scale up the function of the first broker 130 by performing the same function as the first broker 130.

Thus, by forming a duplex structure including the first broker 130 and the second broker 140 that perform the same function, the battery data management apparatus 100 may process a load, which may be concentrated on any one of the first broker 130 or the second broker 140, in a distributed manner.

According to an example embodiment, the battery data management apparatus 100 may drive each of the plurality of functional modules 111, 112, 113, 114, 115, 116, 117, and 118, the first broker 120, the second broker 140, the first controller 130, and the second controller 150 as a separate hardware device to perform a vertical scaling function.

That is, by driving each of the plurality of functional modules 111, 112, 113, 114, 115, 116, 117, and 118, the first broker 120, the second broker 140, the first controller 130, and the second controller 150 of the battery data management apparatus 100 as a separate hardware device, a scale-out function may be performed in which functions processed in one hardware device are distributed into several hardware devices to improve a processing ability.

The first broker 120 and the second broker 140 may share battery data cached from the plurality of functional modules 111, 112, 113, 114, 115, 116, 117, and 118. Thus, the first broker 120 may transmit the battery data cached from at least any one functional module among the plurality of functional modules 111, 112, 113, and 114 to the second broker 140 such that the second broker 140 controls linked operations of the plurality of functional modules 111, 112, 113, and 114. Likewise, the second broker 140 may transmit the battery data cached from at least any one functional module among the plurality of functional modules 115, 116, 117, and 118 to the first broker 120 such that the first broker 120 controls linked operations of the plurality of functional modules 115, 116, 117, and 118.

The second controller 150 may control operations of the plurality of functional modules 110 and the second broker 140. When a failure occurs in at least any one functional module among the plurality of functional modules 111, 112, 113, and 114, the second controller may control another drivable functional module to perform a designated function of the functional module. More specifically, when a failure occurs in at least any one functional module among the plurality of functional modules 111, 112, 113, and 114, the second controller may transmit a control command such that another drivable functional module performs the function.

When a failure occurs in the second broker 140, the second controller 150 may control at least any one function al module among the plurality of functional modules 111, 112, 113, and 114 performing battery data communication with the second broker 140 to perform battery data communication with the first broker 120. That is, the second controller 150 may perform change such that at least any one functional module among the plurality of functional modules 111, 112, 113, and 114 connected to the second broker 140 is connected to the first broker 120.

When a failure occurs in the first broker 120, the first controller 130 may control at least any one function al module among the plurality of functional modules 111, 112, 113, and 114 performing battery data communication with the first broker 120 to perform battery data communication with the second broker 140. That is, the first controller 130 may perform change such that at least any one functional module among the plurality of functional modules 111, 112, 113, and 114 connected to the first broker 120 is connected to the second broker 140.

As described above, with a battery data management apparatus 100 according to an example embodiment disclosed herein, it is possible to quickly process battery data at the same time and efficiently manage battery data, by distributing operations of functional modules.

The battery data management apparatus 100 may perform a horizontal scaling function that drives a plurality of functional modules having relatively low performance without having mounted thereon a high-performance system, installation cost and resources required for maintenance may be reduced.

By performing a vertical scaling function including a broker and a controller that manage and control a plurality of functional modules, the battery data management apparatus 100 may immediately respond to a failure in any one functional module or in the broker, thereby removing a down-time of the system.

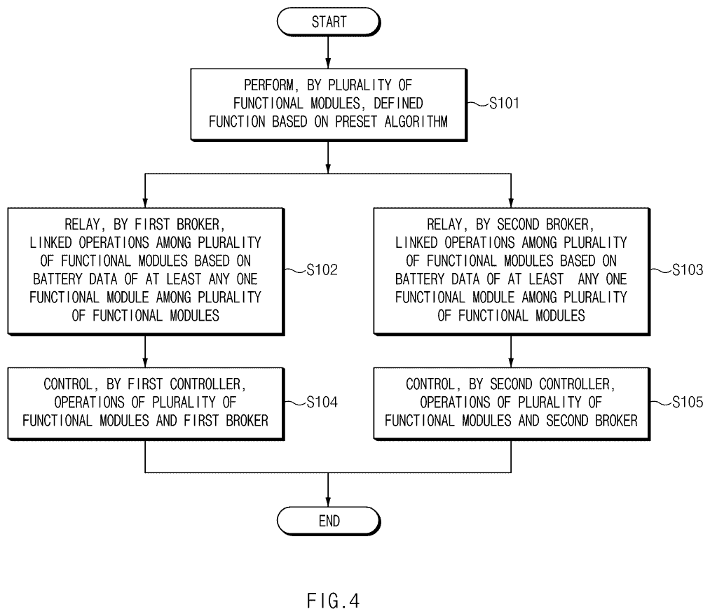

FIG. 4 is a flowchart of an operating method of a battery management apparatus according to an example embodiment disclosed herein. Hereinbelow, an operating method of the battery data management apparatus 100 will be described with reference to FIGS. 1 to 3.

The battery data management apparatus 100 may be substantially the same as the battery data management apparatus 100 described with reference to FIGS. 1 to 3, and thus will be briefly described to avoid redundant description.

Referring to FIG. 6, an operating method of the battery data management apparatus 100 may include operation S101 of performing, by the plurality of functional modules 110, a defined function based on a preset algorithm, operation S102 of relaying, by the first broker 120, linked operations among the plurality of functional modules 110 based on battery data of at least any one functional module among the plurality of functional modules 110, operation S103 of relaying, by the second broker 140, linked operations among the plurality of functional modules 110 based on the battery data of the at least any one functional module among the plurality of functional modules 110, operation S104 of controlling, by the first controller 130, operations of the plurality of functional modules 110 and the first broker 120, and operation S105 of controlling, by the second controller 150, operations of the plurality of functional modules 110 and the second broker 140. Hereinbelow, operations S101 through S105 will be described in detail.

In operation S101, each of the plurality of functional modules 111, 112, 113, and 114 may perform a defined function based on a preset algorithm. For example, each of the plurality of functional modules 111, 112, 113, and 114 may perform any one of battery data communication with the plurality of battery racks 11, 12, 13, and 14, control of the plurality of battery racks 11, 12, 13, and 14, and a UI operation or battery data logging of the ESS 1 to which the battery data management apparatus 100 is applied. That is, the battery data management apparatus 100 may support load distribution by distinguishing functions of each of the plurality of function modules 111, 112, 113, and 114.

In operation S101, each of the plurality of functional modules 111, 112, 113, and 114 may perform a defined function based on a control command of the first controller 130.

In operation S102, the second broker 120 may relay linked operations among a plurality of functional modules 111, 112, 113, and 114 based on the battery data of at least any one function module among the plurality of functional modules 111, 112, 113, and 114.

In operation S102, the first broker 120 may transmit the battery data cached from at least any one functional module among the plurality of functional modules 111, 112, 113, and 114 to the second broker 140 to perform synchronization with the second broker 140.

In operation S103, the second broker 140 may relay linked operations among a plurality of functional modules 111, 112, 113, and 114 based on the battery data of at least any one function module among the plurality of functional modules 111, 112, 113, and 114.

In operation S103, the second broker 140 may transmit the battery data cached from at least any one functional module among the plurality of functional modules 111, 112, 113, and 114 to the first broker 120 to perform synchronization with the first broker 120.

In operation S104, the first controller 130 may control operations of the plurality of functional modules 111, 112, 113, and 114 and the first broker 120.

In operation S104, when a failure occurs in at least any one functional module among the plurality of functional modules 111, 112, 113, and 114, the first controller 130 may control another drivable functional module to perform a designated function of the functional module.

In operation S104, when a failure occurs in the first broker 120, the first controller 130 may control at least any one function al module among the plurality of functional modules 111, 112, 113, and 114 performing battery data communication with the first broker 120 to perform battery data communication with the second broker 140.

In operation S105, the second controller 150 may control operations of the plurality of functional modules 111, 112, 113, and 114 and the second broker 140.

In operation S105, when a failure occurs in at least any one functional module among the plurality of functional modules 111, 112, 113, and 114, the second controller 150 may control another drivable functional module to perform a designated function of the functional module.

In operation S105, when a failure occurs in the first broker 120, the second controller 150 may control at least any one function al module among the plurality of functional modules 111, 112, 113, and 114 performing battery data communication with the second broker 140 to perform battery data communication with the first broker 120.

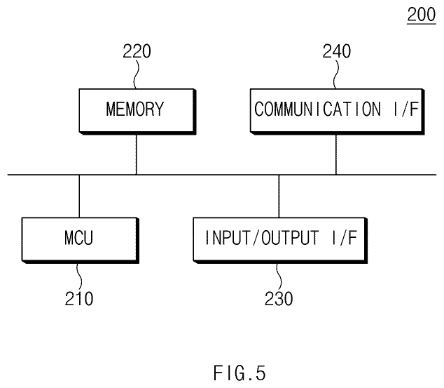

FIG. 5 is a block diagram showing a hardware configuration of a computing system for performing an operating method of a battery data management apparatus, according to an example embodiment disclosed herein.

Referring to FIG. 5, a computing system 200 according to an example embodiment disclosed herein may include an MCU 210, a memory 220, an input/output I/F 230, and a communication I/F 240.

The MCU 210 may be a broker that executes various programs (e.g., a program for monitoring data of a battery, etc.) stored in the memory 220, processes various data through these programs, and performs the above-described functions of the battery data management apparatus 100 shown in FIG. 1.

The memory 220 may store various programs regarding operations of the battery data management apparatus 100. Moreover, the memory 220 may store operation data of the battery data management apparatus 100.

The memory 220 may be provided in plural, depending on a need. The memory 220 may be volatile memory or non-volatile memory. For the memory 220 as the volatile memory, random access memory (RAM), dynamic RAM (DRAM), static RAM (SRAM), etc., may be used. For the memory 220 as the nonvolatile memory, read only memory (ROM), programmable ROM (PROM), electrically alterable ROM (EAROM), erasable PROM (EPROM), electrically erasable PROM

(EEPROM), flash memory, etc., may be used. The above-listed examples of the memory 220 are merely examples and are not limited thereto.

The input/output I/F 230 may provide an interface for transmitting and receiving data by connecting an input device (not shown) such as a keyboard, a mouse, a touch panel, etc., and an output device such as a display (not shown), etc., to the MCU 210.

The communication I/F 240, which is a component capable of transmitting and receiving various data to and from a server, may be various devices capable of supporting wired or wireless communication. For example, a program for resistance measurement and abnormality diagnosis of the battery cell or various data may be transmitted and received to and from a separately provided external server through the communication I/F 240.

The above description is merely illustrative of the technical idea of the present disclosure, and various modifications and variations will be possible without departing from the essential characteristics of the present disclosure by those of ordinary skill in the art to which the present disclosure pertains.

Therefore, the example embodiments disclosed in the present disclosure are intended for description rather than limitation of the technical spirit of the present disclosure and the scope of the technical spirit of the present disclosure is not limited by these example embodiments. The protection scope of the present disclosure should be interpreted by the following claims, and all technical spirits within the same range should be understood to be included in the range of the present disclosure.

1. A battery data management apparatus, comprising:
a plurality of functional modules configured to perform a defined function based on a preset algorithm;
a first broker configured to relay linked operations among the plurality of functional modules based on battery data from at least a first functional module among the plurality of functional modules; and
a first controller configured to control operations of the plurality of functional modules and the first broker.

2. The battery data management apparatus of claim 1, wherein the plurality of functional modules are further configured to perform the defined function based on a control command of the first controller.

3. The battery data management apparatus of claim 1, wherein the plurality of functional modules are further configured to transmit the battery data by performing a battery data communication with the first broker.

4. The battery data management apparatus of claim 1, wherein the first broker is further configured to cache the battery data from at least any one the first functional module among the plurality of functional modules.

5. The battery data management apparatus of claim 4, wherein the first broker is further configured to relay the battery data, cached from at least the first function module, among the plurality of functional modules.

6. The battery data management apparatus of claim 4, wherein the first controller is further configured, if a failure occurs in the first functional module among the plurality of functional modules, to control another functional module to perform the defined function of the first functional module.

7. The battery data management apparatus of claim 1, further comprising:
a second broker configured to relay linked operations among the plurality of functional modules based on battery data from at least a second functional module among the plurality of functional modules; and
a second controller configured to control operations of the plurality of functional modules and the second broker.

8. The battery data management apparatus of claim 7, wherein the first broker and the second broker are further configured to share the battery data cached from the plurality of functional modules.

9. The battery data management apparatus of claim 8, wherein one of the first broker and the second broker is further configured to transmit the battery data cached from one the first or second functional module among the plurality of functional modules to the other of the first broker and the second broker.

10. The battery data management apparatus of claim 7, wherein the first controller or the second controller is further configured, if a failure occurs in one of the first broker and the second broker, to control the first or second functional module among the plurality of functional modules performing a battery data communication with the one of the first broker and the second broker to perform a battery data communication with the other of the first broker and the second broker.

11. An operating method of a battery data management apparatus,
the operating method comprising:
performing, by a plurality of functional modules, a defined function based on a preset algorithm;
relaying, by a first broker, linked operations among the plurality of functional modules based on battery data from at least a first functional module among the plurality of functional modules; and
controlling, by a first controller, operations of the plurality of functional modules and the first broker.

12. The operating method of claim 11, wherein the controlling, by the first controller, of the operations of the plurality of functional modules and the first broker comprises, if a failure occurs in the first functional module among the plurality of functional modules, controlling, by the first controller, another functional module to perform the defined function of the first functional module.

13. The operating method of claim 11, further comprising:
relaying, by a second broker, linked operations among the plurality of functional modules based on battery data from at least a second functional module among the plurality of functional modules; and
controlling, by a second controller, operations of the plurality of functional modules and the second broker.

14. The operating method of claim 13, wherein;
the relaying, by the first broker, of the linked operations among the plurality of functional modules comprises transmitting, by the first broker, the battery data cached from the first functional module among the plurality of functional modules to the second broker, and
the relaying, by the second broker, of the linked operations among the plurality of functional modules comprises transmitting, by the second broker, the battery data cached from the second functional module among the plurality of functional modules to the first broker.

15. The operating method of claim 13, wherein;
the controlling, by the first controller, of the operations of the plurality of functional modules and the first broker comprises, if a failure occurs in the first broker, controlling, by the first controller, at least the first functional module among the plurality of functional modules performing a battery data communication with the first broker to perform a battery data communication with the second broker, and
the controlling, by the second controller, of the operations of the plurality of functional modules and the second broker comprises, if a failure occurs in the second broker, controlling, by the second controller, at least the second functional module among the plurality of functional modules performing a battery data communication with the second broker to perform a battery data communication with the first broker.
